(19) United States
(12) Patent Application Publication
(10) Pub. No.: US 2025/0153296 A1
(43) Pub. Date: May 15, 2025

(54) CUTTING APPARATUS COMPRISING A DOOR GAS CLEANING DEVICE

(71) Applicant: Illinois Tool Works Inc., Glenview, IL (US)

(72) Inventors: Ruibin ZHANG, Shanghai (CN); Hengshan ZOU, Shanghai (CN)

(21) Appl. No.: 18/728,370

(22) PCT Filed: Dec. 30, 2022
(86) PCT No.: PCT/US2022/082625

§ 371 Date: Jul. 11, 2024

(30) Foreign Application Priority Data
Jan. 13, 2022 (CN) 202210037988.3

(51) Int. Cl. B23Q 11/00; B23Q 11/08

(52) U.S. Cl. CPC B23Q 11/005; B23Q 11/0891

(57) ABSTRACT

The present application discloses a cutting apparatus, including: a housing; a door; and a gas cleaning device configured to receive a cleaning gas through the gas inlet and blow the cleaning gas out of the at least one primary gas outlet towards the door to clean the door. The present application uses a gas cleaning device to clean the door, and a gas curtain formed by cleaning gas causes a cutting coolant, chips and sand particles, etc. attached to the cutting door to drip down to a baffle and then return to an operating cavity. Moreover, by controlling the blow-out angle and pressure of the cleaning gas, the cutting coolant, chips and sand particles, etc. can be retained within the range of the operating cavity without dripping onto the outside of the cutting apparatus. Furthermore, as the door is opened, the door moves relatively with the gas cleaning device such that the process of the gas cleaning device cleaning the door is substantially synchronized with the process of opening the door, and no further liquid drips onto the workbench or the ground from the portion of the door passing the gas cleaning device.

### TECHNICAL FIELD

The present application relates to a cutting apparatus, particularly to a cutting apparatus using a cutting coolant.

### BACKGROUND

A general cutting apparatus includes an operating cavity and a door. The cutting apparatus performs cutting operations in the operating cavity, and the door is used to open or close the operating cavity. Moreover, the cutting apparatus can only perform cutting operations after the door closes the operating cavity. Some cutting apparatus also requires the use of cutting coolant during cutting operations. The cutting coolant splashes and adheres to the closed door while the cutting operation is in progress, and drips to the outside of the cutting apparatus as the door opens after the cutting operation is complete.

### SUMMARY

The present application provides a cutting apparatus capable of cleaning the door of the cutting apparatus during the opening of the door, the cutting apparatus including: a housing, a door, and a gas cleaning device. The gas cleaning device includes a gas inlet and at least one primary gas outlet. The housing defines an operating cavity, the housing having a length direction and a height direction. The door is connected to the housing and movably disposed along the length direction of the housing to open or close the operating cavity. The gas cleaning device is located inboard of the door and connected to the housing. The gas inlet can be in fluid communication with the at least one primary gas outlet. Here, the gas cleaning device is configured to receive a cleaning gas through the gas inlet and blow the cleaning gas out of the at least one primary gas outlet towards the door to clean the door.

According to the above, the at least one primary gas outlet includes a plurality of first primary gas outlets. The plurality of first primary gas outlets are arranged generally along the height direction of the housing to form a gas curtain. Here, the gas cleaning device is configured such that the cleaning gas is blown from the plurality of first primary gas outlets towards a portion of the door located downstream of the plurality of first primary gas outlets in a direction in which the door opens the operating cavity.

According to the above, the gas cleaning device further includes a gas distribution portion. A communication channel is provided within the gas distribution portion, and the plurality of first primary gas outlets can be in fluid communication with the gas inlet through the communication channel. Here, the gas distribution portion is configured such that the cleaning gas is blown from the plurality of first primary gas outlets towards the door at an angle of 15° to 30° with the door.

According to the above, the communication channel includes a plurality of first primary gas outlet channels. An outlet of each of the first primary gas outlet channels forms a respective one of the first primary gas outlets. Each of the first primary gas outlet channels is provided with an angle of 15° to 30° with the door to direct the cleaning gas to blow towards the door at an angle of 15° to 30°.

According to the above, the at least one primary gas outlet further includes a plurality of second primary gas outlets. The plurality of second primary gas outlets can be in fluid communication with the gas inlet through the communication channel. The plurality of second primary gas outlets are arranged generally along the height direction of the housing to form a gas curtain. The plurality of second primary gas outlets are disposed upstream of the plurality of first primary gas outlets in a direction in which the door opens the operating cavity. Here, the gas cleaning device is configured such that the cleaning gas is blown towards the door at an angle facing the door from the plurality of second primary gas outlets.

According to the above, the communication channel further includes a plurality of second primary gas outlet channels. An outlet of each of the second primary gas outlet channels forms a respective one of the second primary gas outlets. Each of the second primary gas outlet channels is disposed perpendicular to the door to direct the cleaning gas to blow toward the door at an angle facing the door.

According to the above, the gas distribution portion includes a first side wall and a second side wall. The plurality of first primary gas outlets and the plurality of first primary gas outlet channels are disposed on the first side wall. The plurality of second primary gas outlets and the plurality of second primary gas outlet channels are disposed on the second side wall. Here, the second side wall is parallel to the door, and the first sidewall has an angle of 60° to 75° with the door.

According to the above, the housing further includes a divider and the housing defines a control chamber. The control chamber and the operating cavity are formed in the housing divided by the divider. The gas cleaning device also includes a connection portion. The gas cleaning device is configured to fixedly connect the gas distribution portion to the divider through the connection portion. Further, when the door is at a position where the door closes the operating cavity, the gas cleaning device is located at a front end of the door in a direction of opening the operating cavity.

According to the above, the cutting apparatus further includes a baffle. The baffle is connected to a bottom of the door and is located at the inner side of the door. The baffle extends along the length direction of the housing and is inclined toward a bottom of the housing in a direction from the outside of the door to the inside of the door.

According to the above, the gas cleaning device further includes at least one additional gas outlet. The at least one additional gas outlet can be in fluid communication with the gas inlet through the communication channel. The at least one additional gas outlet is configured to cause the cleaning gas to blow towards the baffle.

According to the above, the gas cleaning device further includes a valve device. The gas inlet is controllably in fluid communication with the communication channel through the valve device.

According to the above, the valve device is configured to fluidly communicate the gas inlet with the communication channel to introduce a cleaning gas into the communication channel during a process of opening the operating cavity by the door.

Other features, advantages, and embodiments of the present application may be set forth or become apparent from consideration of the following detailed description of embodiments, drawings, and claims. Furthermore, it should be understood that the above summary of the invention and the following detailed description of embodiments are exemplary and are intended to provide further explanation without limiting the scope of the claimed application. However, the detailed description of embodiments and specific examples only indicate preferred embodiments of the present application. Various variations and modifications within the spirit and scope of the present application will become apparent to those skilled in the art from the detailed description of embodiments.

### BRIEF DESCRIPTION OF DRAWINGS

FIGS. 1A and 1B are perspective views of a cutting apparatus according to the present application in a state in which an operating cavity is closed and a state in which the operating cavity is open;

FIG. 1C is a perspective view of the cutting apparatus shown in FIG. 1A with the door removed;

FIG. 1D is a partially exploded view of FIG. 1C;

FIG. 2A is a perspective view of a gas cleaning device in FIG. 1D;

FIG. 2B is an exploded view of the gas cleaning device shown in FIG. 2A;

FIG. 2C is a left view of the gas cleaning device shown in FIG. 2A;

FIG. 2D is a cross-sectional view of the gas cleaning device shown in FIG. 2C along line A-A;

FIG. 2E is a front view of the gas cleaning device shown in FIG. 2A;

FIG. 2F is a cross-sectional view of the gas cleaning device of FIG. 2E along line B-B;

FIG. 3A is a perspective view of the door and the gas cleaning device with the door of the cutting apparatus of FIG. 1A at a closed position;

FIG. 3B is a cross-sectional view of the door and the gas cleaning device shown in FIG. 3A along C-C line;

FIG. 3C is a cross-sectional view of the door and the gas cleaning device shown in FIG. 3A;

FIG. 4A is a perspective view of the door and the gas cleaning device during the opening of the door of the cutting apparatus of FIG. 1A;

FIG. 4B is a cross-sectional view of the door and the gas cleaning device shown in FIG. 4A along line D-D;

FIG. 5A is a perspective view of the door and the gas cleaning device of the cutting apparatus of FIG. 1A with the door in an open position;

FIG. 5B is a cross-sectional view of the door and the gas cleaning device shown in FIG. 5A along E-E line.

### DETAILED DESCRIPTION

Various specific embodiments of the present application will be described below with reference to the attached drawings that form a part of the present specification. It should be understood that while terms denoting orientation, such as “front,” “rear,” “upper,” “lower,” “left,” “right,” “top,” “bottom,” “inside,” “outside,” etc., are used in the present application to describe various exemplary structural parts and elements of the present application, these terms are used herein for convenience of illustration only and are determined based on the exemplary orientations shown in the attached drawings. Since the embodiments disclosed in the present application may be disposed in different orientations, these terms denoting orientation are for illustrative purposes only and should not be considered as limiting.

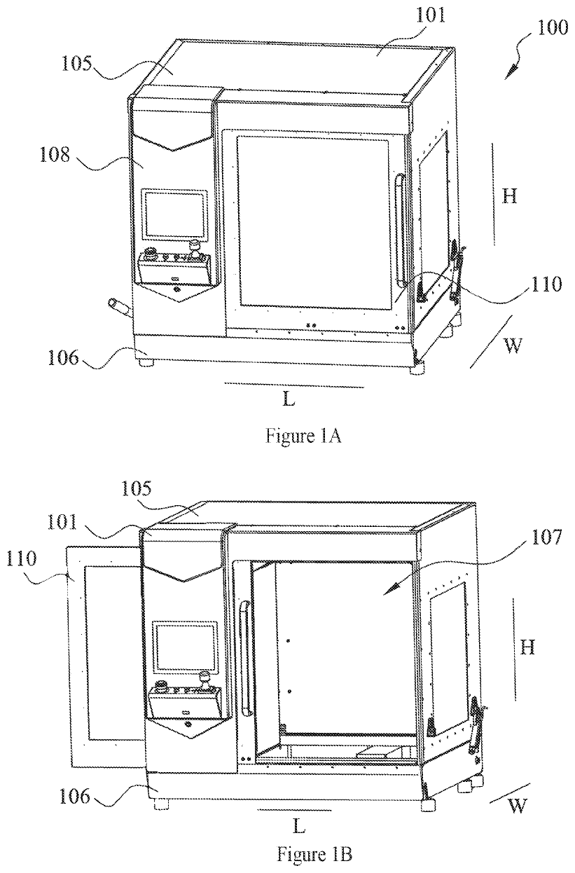

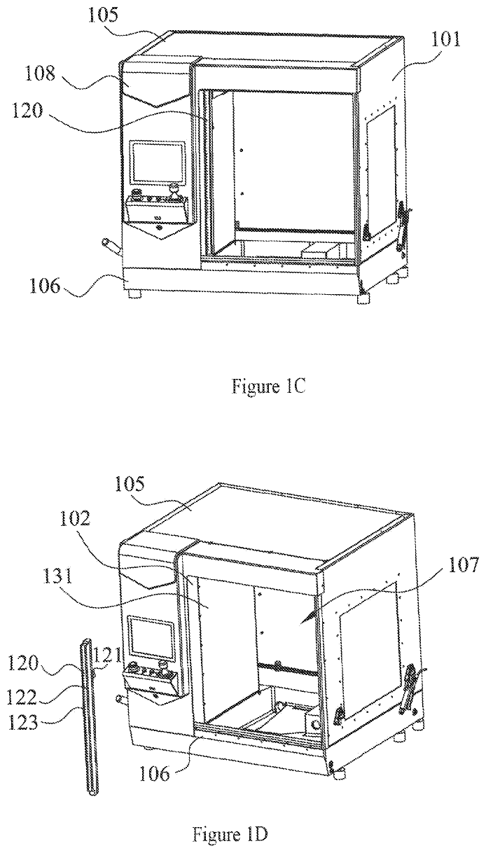

FIGS. 1A to 1D are schematic diagrams of the structure of a cutting apparatus 100 according to the present application for showing the general structure of the cutting apparatus 100, wherein FIG. 1A shows a perspective view of the cutting apparatus 100 when a door 110 closes an operating cavity 107, FIG. 1B shows a perspective view of the cutting apparatus 100 when the door 110 opens the operating cavity 107, FIG. 1C shows a perspective view of the cutting apparatus 100 with the door 110 removed, and FIG. 1D shows a partially exploded view of FIG. 1C.

As shown in FIGS. 1A and 1B, the cutting apparatus 100 includes a housing 101 and the door 110, and the housing 101 is substantially in the shape of a hollow square box with an operating cavity 107 inside. The operating cavity 107 is used to house a cutting piece, etc., for performing a cutting operation in the operating cavity 107. The housing 101 includes a top 105 and a bottom 106 opposite to each other, the bottom 106 of the housing 101 being used to support on a ground or work table. The housing 101 also includes a front portion 108 and a rear portion opposite to each other, the door 110 being movably disposed at the front portion 108 of the housing 101. As the door 110 moves left and right relative to the housing 101, the operating cavity 107 can be opened or closed. In the present embodiment, the door 110 has a closed position as shown in FIG. 1A and an open position as shown in FIG. 1B, and the door 110 is movable between the closed position and the open position along a length direction L. When the door 110 is in the closed position, the door 110 closes the operating cavity 107 and the cutting apparatus 100 may perform a cutting operation. When the cutting operation is complete, the door 110 moves left to its open position. When the door 110 is in the open position, the door 110 opens the operating cavity 107. For ease of description only, in the present embodiment, the upper and lower directions are referred to as a height direction H, the left and right directions are referred to as the length direction L, and the front and rear directions are referred to as a width direction W. In the present embodiment, the housing 101 is in a square shape in which the length, width, and height are substantially the same.

As shown in FIGS. 1C and 1D, the cutting apparatus 100 also includes a gas cleaning device 120. The gas cleaning device 120 is disposed inboard of the door 110 (i.e., the side close to the operating cavity 107) and is fixedly connected with the housing 101 such that the gas cleaning device 120 is stationary relative to the housing 101, the gas cleaning device 120 being moved relative to the door 110 when the door 110 is moved left or right relative to the housing 101. In the present embodiment, when the door 110 is in the closed position, the gas cleaning device 120 is located at the front end of the door 110 in the opening direction (i.e., the left direction), that is, at the left end of the door 110 when in the closed position. When the door 110 is in the open position, the gas cleaning device 120 is located at the front end of the door 110 in the closed direction (i.e., the right direction), that is, at the right end of the door 110 when in the open position. The gas cleaning device 120 has a gas inlet 121 and a plurality of primary gas outlets 122, 123, the plurality of primary gas outlets 122, 123 being arranged approximately along the height direction H of the housing 101. The plurality of primary gas outlets 122, 123 are disposed towards the door 110. The gas inlet 121 is used to receive cleaning gas, and the gas inlet 121 and these gas outlets 122, 123 are in fluid communication to enable the cleaning gas received from the gas inlet 121 to be blown out from the primary gas outlets 122, 123 towards the door 110. In the present application, the cleaning gas is compressed air having a certain pressure, such as a pressure of 0.6 to 1 MPa of the cleaning gas input from the gas inlet 121. As such, the gas blown out of each primary gas outlet 122, 123 also has a certain pressure.

The housing 101 also includes a divider 131 connected inside the housing 101 to divide the inside of the housing 101 to form an operating cavity 107 and a control chamber 102 located to the left of the operating cavity 107. The control chamber 102 is used to house a control system (not shown in the figures) for controlling apparatus such as cutting pieces. In the present embodiment, the gas cleaning device 120 is connected to the divider 131 and the primary gas outlets 122 and 123 are towards and proximate the inner side of the door 110. It will be appreciated by those skilled in the art that the gas cleaning device 120 may also be connected elsewhere in the housing 101. For example, the gas cleaning device 120 may also be connected to the top 105 and the bottom 106 of the housing 101.

Referring to FIGS. 1A to 1D, during the movement of the door 110 from the closed position to the open position, the gas cleaning device 120 is stationary and the door 110 moves relative to the gas cleaning device 120, i.e., the gas cleaning device 120 moves right relative to the door. As such, the gas flow of the cleaning gas blown out by the gas cleaning device 120 blows off liquid attached to the inner side of the door 110 towards the right side of the door 110 after touching the door 110, thereby enabling the gas cleaning device 120 to gradually clean the entire door 110 from the left end to the right end of the door 110 as the door 110 is opened.

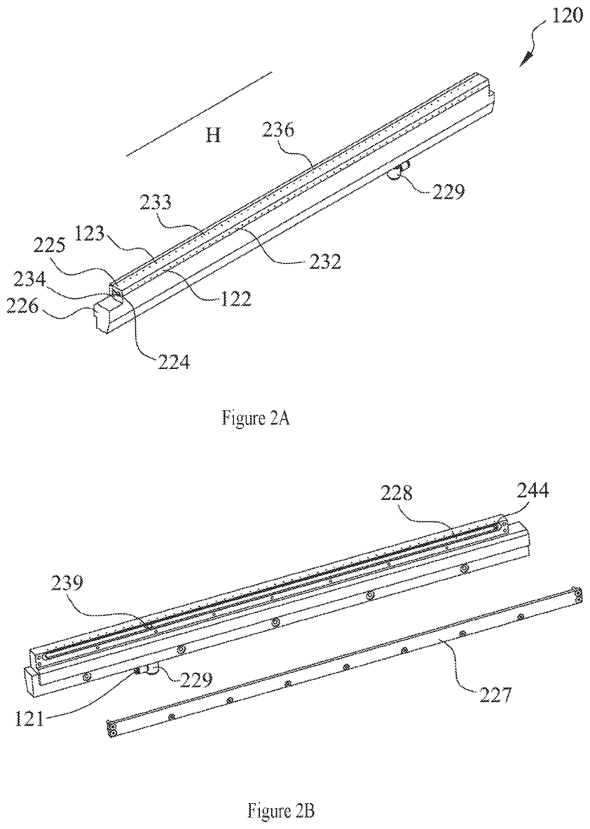

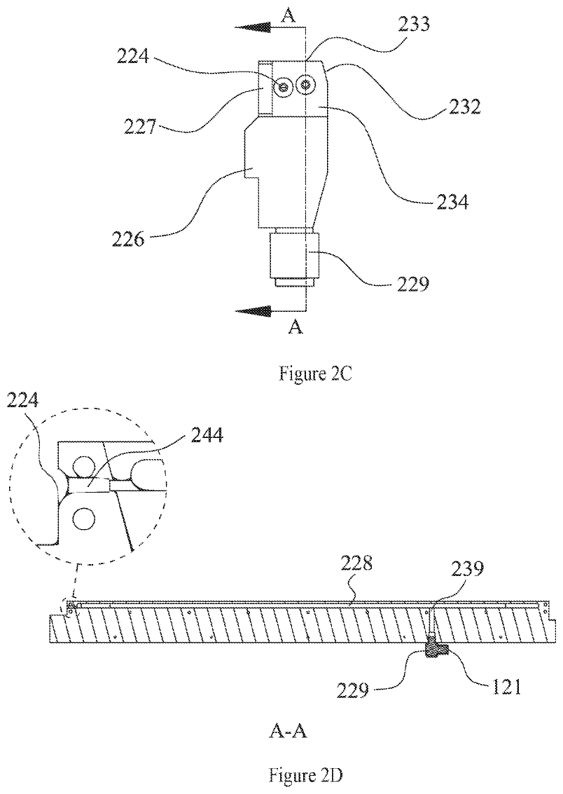

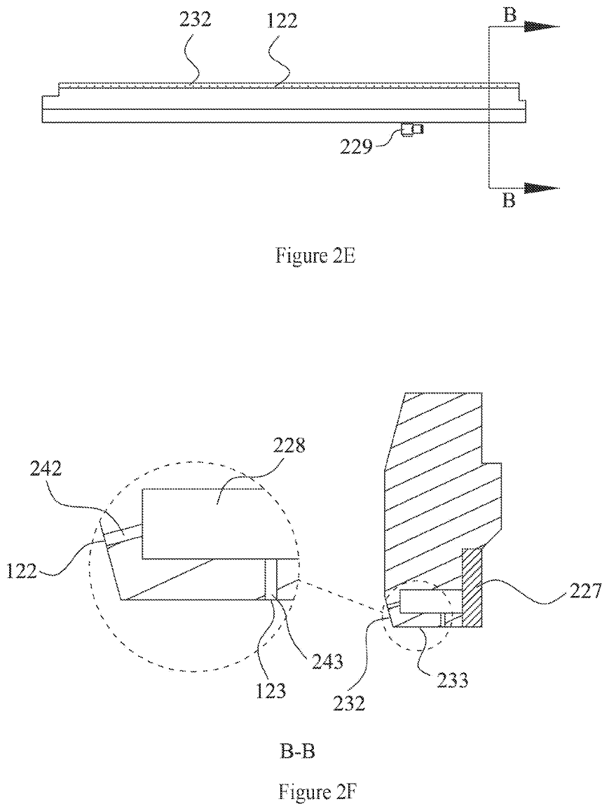

FIGS. 2A to 2F illustrate specific structures of the gas cleaning device 120. FIG. 2A is a perspective view of the gas cleaning device 120, FIG. 2B is an exploded view of the gas cleaning device 120, FIG. 2C is a left view of the gas cleaning device 120 shown in FIG. 2A, FIG. 2D is a cross-sectional view of the gas cleaning device 120 of FIG. 2C along the A-A line, FIG. 2E is a front view of the gas cleaning device 120 shown in FIG. 2A, and FIG. 2F is a cross-sectional view of the gas cleaning device 120 of FIG. 2E along the B-B line, with a dashed box representing a partially enlarged view.

As shown in FIGS. 2A to 2F, the gas cleaning device 120 includes a stub-shaped gas distribution portion 225 and a stub-shaped connection portion 226, the gas distribution portion 225 and the connection portion 226 having a common length direction, and the gas distribution portion 225 being connected above the connection portion 226. The gas distribution portion 225 is used to blow cleaning gas out from each gas outlet towards the door 110, and the connection portion 226 is used to fixedly connect the gas distribution portion 225 to the housing 101. As one example, the gas cleaning device 120 is made of metal and the gas distribution portion 225 and the connection portion 226 are made integrally by machinery processing.

In particular, the gas distribution portion 225 is generally hollow in the shape of a long rod, with its length direction as the height direction H of the housing 101, with an empty interior forming a communication channel 228. In the present embodiment, the gas distribution portion 225 is polyhedron-shaped, having a plurality of side walls 236 extending along its length and two end walls 234 connected both ends of the plurality of side walls 236. The plurality of primary gas outlets 122, 123 include a plurality of first primary gas outlets 122 and a plurality of second primary gas outlets 123, a first side wall 232 and a second side wall 233 of the plurality of side walls 236 being respectively used to provide the plurality of first primary gas outlets 122 and the plurality of second primary gas outlets 123 that are in fluid communication through the communication channel 228. A third side wall of the plurality of side walls 236 is formed by a cover plate 227 that detachably closes the communication channel 228 from a side of the gas distribution portion 225.

A plurality of first primary gas outlets 122 and a plurality of second primary gas outlets 123 are respectively disposed on the first side wall 232 and the second side wall 233 of the gas distribution portion 225, and are generally arranged along the height direction H, so that cleaning gas blown from the first primary gas outlet 122 and the second primary gas outlet 123 can form a gas curtain to be blown towards the inner side of the door 110. In the present embodiment, the communication channel 228 also extends generally along the height direction H, enabling fluid communication with each of the gas outlets 122 and 123. In other embodiments, the communication channel 228 may also be other shapes as long as it is capable of communicating with the gas outlet.

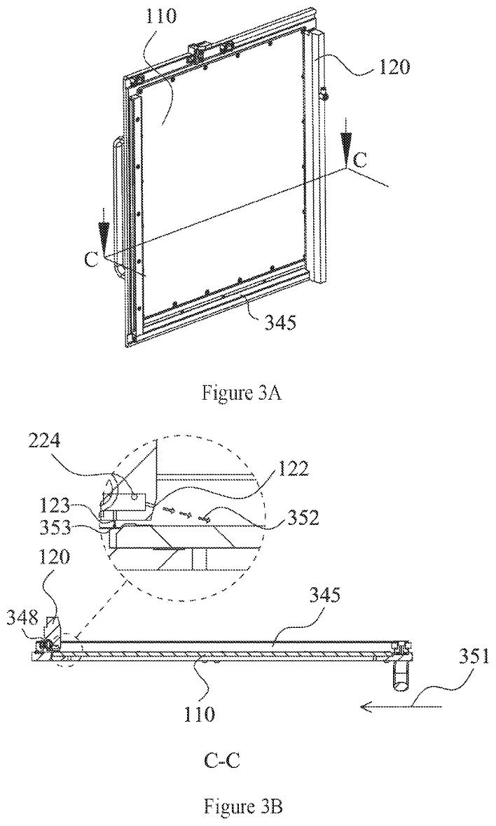

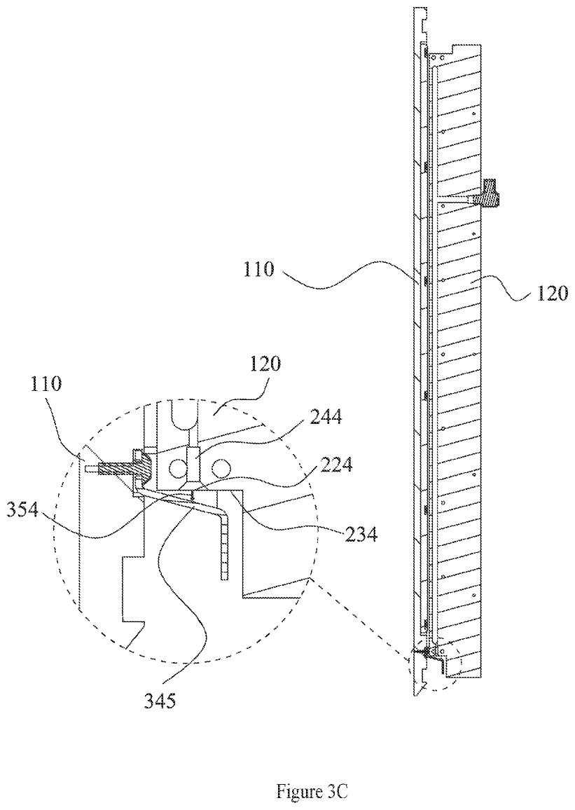

In the present embodiment, the communication channel 228 further includes a plurality of first primary gas outlet channels 242 and a plurality of second primary gas outlet channels 243 to enable the cleaning gas to be blown towards the door 110 at a predetermined angle. The outlet of each first primary gas outlet channel 242 forms a first primary gas outlet 122 and the outlet of each second primary gas outlet channel 243 forms a second primary gas outlet 123. The first and second primary gas outlet channels 242, 243 are used to direct the gas flow direction of the cleaning gas blown out from the respective outlets. As one example, the first primary gas outlet channel 242 extends perpendicularly through the first side wall 232 and the second primary gas outlet channel 243 extends perpendicularly through the second side wall 233. In an embodiment of the present application, the first side wall 232 is not perpendicular to the second side wall 233, but has an angle with the second side wall 233 of approximately 60° to 75°. Thus, the first primary gas outlet channel 242 and the second primary gas outlet channel 243 also have an angle of 60° to 75°. The first primary gas outlet channel 242 directs the cleaning gas to be blown towards the door 110 at an angle of 15° to 30° with the door 110, and the second primary gas outlet channel 243 directs the cleaning gas to be blown perpendicular to the door 110 (see FIG. 3B).

In the present embodiment, the primary gas outlet channels 242 and 243 and the first and second side walls 232, 233 are provided to ensure that the cleaning gas is blown towards the door 110 at a predetermined angle. At the predetermined angle, the gas flow formed by the cleaning gas can have a greater coverage inside the door 110 and the gas flow does not create an uncomfortable feeling to an operator outside the door 110. It will be appreciated by those skilled in the art that when the pressure of the cleaning gas is sufficient, there is no need to provide a gas outlet channel, and the angle at which the cleaning gas is blown to the door 110 can be controlled only by controlling the angle between each side wall and the door 110. In other embodiments, the gas distribution portion 225 may also guide the blow-out direction of the cleaning gas by providing only a gas outlet channel without providing a side wall, or providing more side walls.

By setting the number and spacing of the first primary gas outlets 122 and the second primary gas outlets 123, when the pressure of the cleaning gas input from the gas inlet 121 is certain, the cleaning gas blown out from each first primary gas outlet 122 and each second primary gas outlet 123 can have a suitable pressure that allows a cutting coolant adhering to the inner side of the door 110 to be blown off or flow along the door 110, but the cutting coolant will not be blown off the right end of the door 110 even when the door 110 is in the open position.

The gas inlet 121 is connected below the connection portion 226 by a valve device 229 and the gas inlet 121 is disposed towards the operating cavity 107 to connect the gas inlet 121 with a source of compressed air within the operating cavity 107. A through hole 239 is provided in the connection portion 226, and the through hole 239 runs through the connection portion 226. One end of the through hole 239 is in communication with the communication channel 228, and the other end is in communication with the valve device 229 and the gas inlet 121. As such, the gas inlet 121 is controllably in fluid communication with the communication channel 228 through the valve device 229. By controlling the opening or closing of the valve device 229, a cleaning gas can be controllably introduced from the gas inlet 121 into the communication channel 228.

There is also at least one additional gas outlet 224 on one of the end walls 234 of the gas distribution portion 225, the communication channel 228 further including an additional gas outlet channel 244, the outlet of the additional gas outlet channel 244 forming an additional gas outlet 224. The additional gas outlet 224 may also be in fluid communication with the gas inlet 121 via the communication channel 228 to blow cleaning gas out of the additional gas outlet 224. In the present embodiment, a baffle 345 is connected to the bottom of the door 110, and the baffle 345 is located inboard of the door 110 and extends along the length direction L. The baffle 345 is inclined towards the bottom 106 of the housing 101 in a direction from the outside to the inside (see FIGS. 3A and 3C). The cleaning gas is blown from the additional gas outlet 224 towards the baffle 345 to blow the cutting coolant or the like on the baffle 345 back into the operating cavity 107.

FIGS. 3A to 3C show a mating structure of the door 110 and the gas cleaning device 120 when the door 110 is in the closed position for detailing the position relationship of the door 110 and the gas cleaning device 120. Here, FIG. 3A is a perspective view of the door 110 and the gas cleaning device 120 viewed outwards from within the cutting apparatus, FIG. 3B shows a cross-sectional view of FIG. 3A along the C-C line, and FIG. 3C shows a cross-sectional view of FIG. 3A along the A-A line in FIG. 2C, with a dashed box representing a partially enlarged view.

As shown in FIGS. 3A and 3B, when the door 110 is in the closed position, the gas cleaning device 120 is at the front end of the door 110 in the opening direction, and the cover plate 227 of the gas cleaning device 120 abuts against a sealant strip 348 inside the door 110 to prevent leakage of the cutting coolant or the like inside of the door 110 between the door 110 and the gas cleaning device 120. At the angle shown in FIG. 3B, the upper side of the door 110 is the side of the operating cavity 107 and the lower side of the door 110 is the side outside of the cutting apparatus. The door 110 opens along the direction of an arrow 351. That is, the opening direction of the door 110 is left, and the gas cleaning device 120 is located at the left end of the door 110. Moreover, in the opening direction of the door 110, the second primary gas outlet 123 is disposed upstream of the first primary gas outlet 122, that is, the second primary gas outlet 123 is disposed to the left of the first primary gas outlet 122.

The cleaning gas blown out of the first primary gas outlet 122 forms a first gas flow 352 that is in a direction generally reversed or non-opposed to the opening direction of the door 110, so that the first gas flow 352 can blow off the cutting coolant or the like attached to the inner side of the door 110 towards the right side of the door 110, and the liquid drips directly or integrates and drips onto the baffle 345. In the present embodiment, the first side wall 232 has an angle of approximately 60° to 75° with the door 110, and the first primary gas outlet channel 242 is provided to have an angle of 15° to 30° with the door 110 to direct the first gas flow 352 blown out of the first primary gas outlet 122 to blow towards a portion of the door 110 located downstream of the first primary gas outlet 122 in the opening direction (i.e., left direction) at an angle of 15° to 30° with the door 110. In the present application, the “upstream” and “downstream” are for the direction of movement of the door 110. In other words, that the first gas flow 352 blows towards the portion of the door downstream of the first primary gas outlet 122 refers to that the first gas flow 352 generally blows towards the portion of the door 110 on the right side of the first primary gas outlet 122.

Also, the cleaning gas blown out of the second primary gas outlet 123 forms a second gas flow 353, which is in a direction generally facing the door 110, so that the second gas flow 353 can blow away the cutting coolant or the like attached to the inner side of the door 110, such as to the left and right sides of the door 110, and as a result, the cutting coolant or the like drips directly or integrates and drips onto the baffle 345. When the door 110 is in the closed position shown in FIGS. 3A to 3C, since the left side of the gas cleaning device 120 abuts against the sealant strip 348, the blown cutting coolant, etc., can only be blown to the right to drip directly or integrate and drip onto the baffle 345. In the present embodiment, the second side wall 233 is substantially parallel to the door 110, and the second primary gas outlet channel 243 is provided perpendicular to the door 110 to direct the second gas flow 353 blown out of the second primary gas outlet 123 to blow towards a portion of the door 110 located upstream of the first primary gas outlet 122 in the opening direction (i.e., the left direction) at an angle perpendicular to the door 110. As such, when the door 110 is in the closed position, even if the first primary gas outlet 122 is only able to blow towards the portion of the door corresponding to the right of the first primary gas outlet 122, the portion of the door corresponding to the left of the first primary gas outlet 122 can also be cleaned by the cleaning gas blown out of the second primary gas outlet 123.

With further reference to FIG. 3C, the end wall 234 is generally perpendicular to the door 110, and the additional gas outlet channel 244 is provided parallel to the door 110 to direct a third gas flow 354 formed by the cleaning gas blown out from the additional gas outlet 224 to blow towards the baffle 345 at an angle generally parallel to the door 110 so that the cutting coolant or the like blown onto the baffle 345 by the first gas flow 352 and the second gas flow 353 can be blown back into the operating cavity 107 by the third gas flow 354, thereby cleaning the door 110.

The gas cleaning device 120 is configured to, during the opening of the door 110, the valve device 229 fluidly communicates the gas inlet 121 with the communication channel 228 to introduce cleaning gas into the communication channel 228 and blow the cleaning gas out from each gas outlet at a predetermined angle to clean the door 110 as the opening process of the door 110 proceeds. In some embodiments, the door 110 may also include an unlocking device (not shown in the figure) for locking the door 110 in the closed position. After the unlocking device is unlocked, the valve device 229 begins to introduce cleaning gas into the communication channel 228 before the door 110 opens. As a result, the cleaning gas can be blown out from each gas outlet when the door 110 is in the closed position.

As the door 110 moves from the closed position towards the open position in the opening direction, the door 110 moves left relative to the gas cleaning device 120, and the first gas flow 352 blows towards the right side of the door 110, blowing the cutting coolant attached to the door 110 towards the right end of the door 110.

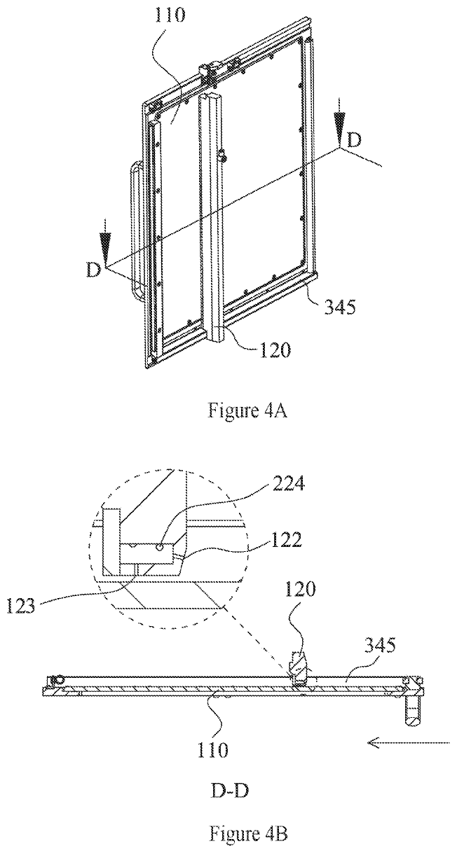

FIGS. 4A and 4B show a mating structure of the door 110 and the gas cleaning device 120 during the opening process of the door 110. FIG. 4A is a perspective view of the door 110 and the gas cleaning device 120, and FIG. 4B shows a cross-sectional view of FIG. 4A along the D-D line, with a dashed box representing a partially enlarged view. As shown in FIGS. 4A and 4B, with the movement of the door 110 relative to the gas cleaning device 120, a portion of the door 110 located to the left of the gas cleaning device 120 has exited the range of the operating cavity 107, and the inner side of the portion of the door 110 is no longer adhered with the cutting coolant, essentially in a dry state. The portion of the door 110 located to the right of the gas cleaning device 120 is still within the range of the operating cavity 107.

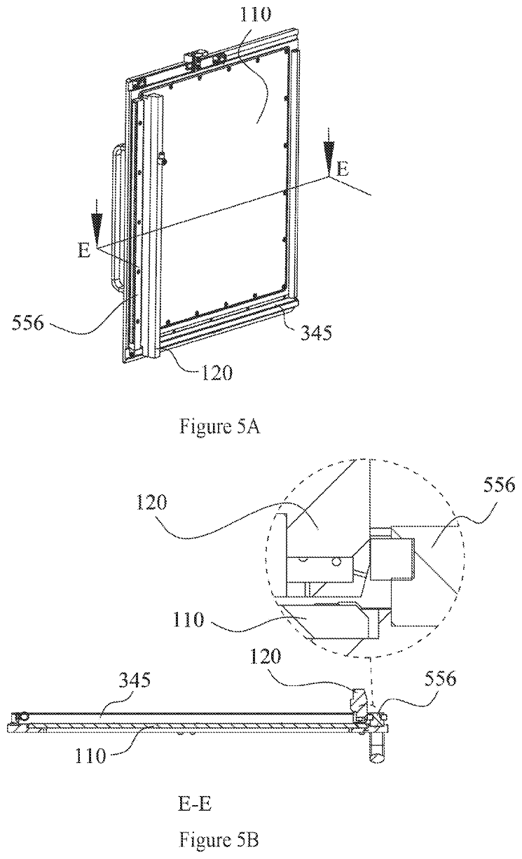

FIGS. 5A and 5B show a mating structure of the door 110 and the gas cleaning device 120 when the door 110 is in the open position. FIG. 5A is a perspective view of the door 110 and the gas cleaning device 120, and FIG. 5B shows a cross-sectional view of FIG. 5A along the E-E line, with a dashed box representing a partially enlarged view. As shown in FIGS. 5A and 5B, as the door 110 is opened, the first gas flow 352 further blows towards the right side of the door 110 until the door 110 reaches the open position, and the gas cleaning device 120 is blocked by a stop bar 556 at the right side edge of the door 110 so that the door 110 cannot continue to move left relative to the gas cleaning device 120. At this point, the first gas flow 352 blows the cutting coolant at the inner side of the door 110 to the right edge of the door 110, and the cutting coolant is blocked by the stop bar 556, dripping down the stop bar 556 onto the baffle 345, and is then blown back into the operating cavity 107. As such, the cutting coolant or the like attached to the inner side of the entire door 110 can be cleaned by the gas cleaning device 120.

The cutting coolant, etc., is easily splashed and attached to the closed door when the cutting apparatus is operated for cutting, and when the operation of the cutting apparatus ends and the door is opened, the cutting coolant, etc., attached to the door drips onto a workbench or floor outside the cutting apparatus. Some cutting coolants that contain rust inhibitors often have a pungent odor that can affect the work environment if they drip outside the cutting apparatus.

The applicant has found that the cutting coolant attached to the inner side of the door of the cutting apparatus is generally in the form of small droplets, and can be more stably attached to the door under the action of liquid surface tension. In addition, during the cutting operation, the cutting apparatus also produces chips and shredded sand particles that can be attached to the inner side of the door along with the small droplet-shaped cutting coolant. When the door is open, the cutting coolant, chips, and sand particles, etc. may drip down outside the cutting apparatus for reasons such as sliding and shaking.

The present application uses a gas cleaning device to clean a door. A gas curtain formed by cleaning gas can blow cutting coolant, chips and sand particles attached to the door, so that a portion of the cutting coolant, chips and sand particles leave the inner surface of the door, drip down to a baffle under the action of gravity, and then return to an operating cavity. The other portion of the cutting coolant, chips and sand particles can be pushed along the inner surface of the door by the gas curtain to the edge of the door, so that the cutting coolant in the form of small liquid droplets integrates into larger liquid droplets, drips together with the chips, sand particles, etc. down to the baffle, and then return to the operating cavity. Moreover, by controlling the blow-out angle and pressure of the cleaning gas, the cutting coolant, chips, and sand particles at the inner side of the door can be retained within the range of the operating cavity without dripping onto the outside of the cutting apparatus. Furthermore, as the door is opened, the door moves relatively with the gas cleaning device such that the process of the gas cleaning device cleaning the door is substantially synchronized with the process of opening the door, and no further liquid drips onto the workbench or the ground from the portion of the door passing the gas cleaning device.

The gas cleaning device of the present application has a simple structure that only requires to add a gas cleaning device to an existing cutting apparatus, which is a small modification to the existing cutting apparatus. Moreover, it has good cleaning effect on the door, and thus it will not cause wear on the observation glass on the door during the cleaning process.

Although the present disclosure has been described in connection with examples of the embodiments outlined above, various alternatives, modifications, variations, improvements, and/or substantial equivalents, whether known or foreseeable now or in the near future, may be apparent to those having at least ordinary skill in the art. In addition, the technical effects and/or technical problems described in the present specification are exemplary and not limiting; therefore, the disclosure in the present specification may be used to solve other technical problems and have other technical effects and/or may solve other technical problems. Therefore, examples of embodiments of the present disclosure as set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents.

What is claimed is:

1. A cutting apparatus comprising:
a housing defining an operating cavity, the housing having a length direction (L) and a height direction (H);
a door connected to the housing and movably disposed along the length direction of the housing to open or close the operating cavity; and
a gas cleaning device located inboard of the door and connected to the housing, the gas cleaning device including a gas inlet and at least one primary gas outlet, the gas inlet being capable of being in fluid communication with the at least one primary gas outlet, wherein the gas cleaning device is configured to receive a cleaning gas through the gas inlet and blow the cleaning gas out of the at least one primary gas outlet towards the door to clean the door.

2. The cutting apparatus according to claim 1, wherein:
the at least one primary gas outlet includes a plurality of first primary gas outlets arranged generally along the height direction (H) of the housing to form a gas curtain, wherein the gas cleaning device is configured such that the cleaning gas is blown from the plurality of first primary gas outlets to a portion of the door located downstream of the plurality of first primary gas outlets in a direction of opening the operating cavity.

3. The cutting apparatus according to claim 2, wherein:
the gas cleaning device further includes a gas distribution portion within which a communication channel is provided, the plurality of first primary gas outlets being in fluid communication with the gas inlet through the communication channel;
wherein the gas distribution portion is configured such that the cleaning gas is blown from the plurality of first primary gas outlets towards the door at an angle of 15° to 30° with the door.

4. The cutting apparatus according to claim 3, wherein:
the communication channel includes a plurality of first primary gas outlet channels, an outlet of each of the first primary gas outlet channels forming a respective one of the first primary gas outlets, each of the first primary gas outlet channels being provided with an angle of 15° to 30° with the door to direct the cleaning gas to blow towards the door at an angle of 15° to 30°.

5. The cutting apparatus according to claim 4, wherein:
the at least one primary gas outlet further includes a plurality of second primary gas outlets that can be in fluid communication with the gas inlet via the communication channel, the plurality of second primary gas outlets are arranged substantially along the height direction (H) of the housing to form a gas curtain, and the plurality of second primary gas outlets are disposed upstream of the plurality of first primary gas outlets in a direction in which the door opens the operating cavity;
wherein the gas cleaning device is configured such that the cleaning gas is blown towards the door at an angle facing the door from the plurality of second primary gas outlets.

6. The cutting apparatus according to claim 5, wherein:
the communication channel further includes a plurality of second primary gas outlet channels, an outlet of each of the second primary gas outlet channels forming a respective one of the second primary gas outlets, each of the second primary gas outlet channels being disposed perpendicular to the door to direct the cleaning gas to blow towards the door at an angle facing the door.

7. The cutting apparatus according to claim 6, wherein:
the gas distribution portion includes a first side wall and a second side wall, the plurality of first primary gas outlets and the plurality of first primary gas outlet channels disposed on the first side wall, the plurality of second primary gas outlets and the plurality of second primary gas outlet channels disposed on the second side wall;
wherein the second side wall is parallel to the door, the first side wall having an angle of 60° to 75° with the door.

8. The cutting apparatus according to claim 7, wherein:
the housing further includes a divider and the housing defines a control chamber, the control chamber and the operating cavity formed in the housing divided by the divider;
the gas cleaning device further includes a connection portion, and the gas cleaning device is configured to fixedly connect the gas distribution portion to the divider through the connection portion, and when the door is at a position where the operating cavity is closed, the gas cleaning device is located at a front end of the door in a direction of opening the operating cavity.

9. The cutting apparatus according to claim 3, wherein:
the cutting apparatus further includes a baffle connected to a bottom of the door and located inboard of the door, the baffle extending along the length direction (L) of the housing and being inclined toward a bottom of the housing in a direction from outside of the door to inside of the door.

10. The cutting apparatus according to claim 9, wherein:
the gas cleaning device further includes at least one additional gas outlet that can be in fluid communication with the gas inlet via the communication channel, the at least one additional gas outlet configured to cause the cleaning gas to blow toward the baffle.

11. The cutting apparatus according to claim 3, wherein:
the gas cleaning device further includes a valve device through which the gas inlet is controllably in fluid communication with the communication channel.

12. The cutting apparatus according to claim 11, wherein:
the valve device is configured to fluidly communicate the gas inlet with the communication channel to introduce a cleaning gas into the communication channel during a process of opening the operating cavity by the door.
